(19) United States
(12) Patent Application Publication
(10) Pub. No.: US 2012/0256924 A1
(43) Pub. Date: Oct. 11, 2012

(54) IMAGE SUPPLY DEVICE, DISPLAY SYSTEM, IMAGE SUPPLY METHOD, AND INFORMATION RECORDING MEDIUM

(75) Inventor: Shinya UEMA, Sapporo-shi (JP)

(73) Assignee: Seiko Epson Corporation, Tokyo (JP)

(21) Appl. No.: 13/438,274

(22) Filed: Apr. 3, 2012

(30) Foreign Application Priority Data
Apr. 6, 2011 (JP) 2011-084249

(51) Int. Cl. G06T 17/00

(52) U.S. Cl. 345/428

(57) ABSTRACT

An image supply device capable of communicating with an image display device adapted to display an image with a predetermined display resolution includes a transmission image data generator adapted to generate transmission image data with a resolution lower than a display resolution of the image display device, and a transmitter adapted to transmit the transmission image data generated by the transmission image data generator to the image display device.

The entire disclosure of Japanese Patent Application No. 2011-084249 filed Apr. 6, 2011 is expressly incorporated by reference herein.

### BACKGROUND

1. Technical Field

The present invention relates to an image supply device, a display system, an image supply method, and an information recording medium.

2. Related Art

In the past, there has been known a usage of transmitting image data from a device such as a personal computer to a display device such as a projector. Specifically, there has been known a method of developing image data on the computer side and then transmitting it to the destination device.

The image data is apt to have a large data amount, and if the band of the transmission channel is not sufficient, it takes time to transmit the data. Further, in the case of using a communication channel a plurality of computers uses in common, the band is occupied, and the communication between other computers might be affected. Therefore, as a method of reducing the transfer time, there has been disclosed a method of dividing the screen into blocks as bitmap data, and decreasing the number of indexes if the number of colors is small, to thereby transmit them in an compressed form (see, e.g., JP-A-10-74173).

In recent years, development of high-resolution display devices such as television systems or projectors has been progressed, and images to be transmitted have also been made high-resolution. Therefore, according to the conventional method described above, since the load in the process of developing the image into the bitmap data and then treating the indexes is heavy, it has become difficult to reduce the amount of data efficiently. On the other hand, the transfer data amount grows steadily with the increase in image resolution, and therefore, a method of reducing the amount of data to be transferred has been desired.

### SUMMARY

An advantage of some aspects of the invention is to efficiently reduce the transfer data amount in the case of transferring image data to a display device for displaying the image.

An aspect of the invention is directed to an image supply device capable of communicating with an image display device adapted to display an image with a predetermined display resolution including a transmission image data generator adapted to generate transmission image data with a resolution lower than a display resolution of the image display device, and a transmitter adapted to transmit the transmission image data generated by the transmission image data generator to the image display device.

According to this aspect of the invention, since the image supply device for transmitting the image data to the image display device generates and then transmits the transmission image data with the resolution lower than the display resolution of the image display device, the amount of the data to be transmitted to the image display device can be reduced without performing the process with heavy load.

Another aspect of the invention is directed to the image supply device described above, which further includes a display having one of a display screen and a virtual display screen each adapted to display an image, and the transmission image data generator generates the transmission image data with which the image display device displays an image presently displayed on one of the display screen and the virtual display screen by the display.

According to this aspect of the invention, since the image supply device transmits the image data of the image, which is to be displayed on the display screen or the virtual display screen, to the image display device, the image data can be transmitted to the image display device by a process with low load.

Still another aspect of the invention is directed to the image supply device described above, wherein the transmission image data generator generates the transmission image data with a resolution one of equal to and lower than the display resolution of one of the display screen and the virtual display screen of the display.

According to this aspect of the invention, since the image supply device transmits the image data of the image, which is to be displayed on the display screen or the virtual display screen, as the image data with lower resolution, the amount of the data to be transmitted to the image display device can be reduced by a process with lower load.

Yet another aspect of the invention is directed to the image supply device described above, wherein the transmission image data generator generates the transmission image data compressed with a predetermined compression format.

According to this aspect of the invention, the data amount of the image data to be transmitted from the image supply device to the image display device can be made smaller.

Still yet another aspect of the invention is directed to the image supply device described above, wherein the transmission image data generator generates the transmission image data compressed with a compression format selected from a plurality of compression formats, and is configured so as to be able to set the resolution of the transmission image data to a plurality of levels, and the setting value of a data amount of the transmission image data can be set to a plurality of levels by selecting the compression format and the resolution of the transmission image data.

According to this aspect of the invention, since the data amount of the transmission image data can be set to a plurality of levels by selecting the compression format and the resolution, the optimum condition with good balance between the load on the process and the data amount can be set.

Further another aspect of the invention is directed to a display system including an image display device adapted to display an image with a predetermined display resolution, and an image supply device connected to the image display device so as to be able to communicate with each other, wherein the image supply device includes a transmission image data generator adapted to generate transmission image data with a resolution lower than a display resolution of the image display device, and a transmitter adapted to transmit the transmission image data generated by the transmission image data generator to the image display device, and the image display device includes a receiver adapted to receive the transmission image data transmitted from the image supply device, a resolution converter adapted to generate image data for display suitable for the predetermined display resolution based on the transmission image data received by the receiver, and a display adapted to display an image based on the image data for display generated by the resolution converter.

According to this aspect of the invention, since the image supply device generates the transmission image data with the resolution lower than the display resolution of the image display device, and then transmits the transmission image data to the image display device, the amount of the data to be transmitted to the image display device can be reduced without performing the process with heavy load.

Still further another aspect of the invention is directed to the display system described above, there is provided a configuration in which the image display device and a plurality of the image supply devices are connected to each other via a communication network so as to be able to communicate with each other, and the image supply devices can communicate with each other via the communication network.

According to this aspect of the invention, since the communication channel for transmitting the image data from the image supply device to the image display device is the communication network, which can be used for the communication between other image supply devices, the image data can be transmitted from the image supply device to the image display device via the communication network without occupying the band. Therefore, the communication between other image supply devices becomes possible, and at the same time, the transmission of the image data exerts no substantial influence on the communication between other image supply devices.

Yet further another aspect of the invention is directed to an image supply method including: allowing a device connected to an image display device adapted to display an image with a predetermined display resolution so as to be able to communicate with the image display device to generate transmission image data with a resolution lower than a display resolution of the image display device, and to transmit the transmission image data to the image display device.

According to this aspect of the invention, since the image supply device generates the transmission image data with the resolution lower than the display resolution of the image display device, and then transmits the transmission image data to the image display device, the amount of the data to be transmitted to the image display device can be reduced without performing the process with heavy load.

Still yet further another aspect of the invention is directed to a program executable by a computer connected to an image display device adapted to display an image with a predetermined resolution so as to be able to communicate with the image display device, the program allowing the computer to: generate transmission image data with a resolution lower than a display resolution of the image display device, and transmit the generated transmission image data to the image display device.

According to this aspect of the invention, since the image supply device generates the transmission image data with the resolution lower than the display resolution of the image display device, and then transmits the transmission image data to the image display device, the amount of the data to be transmitted to the image display device can be reduced without performing the process with heavy load.

A further aspect of the invention is directed to an information recording medium storing a program in a manner readable by a computer connected to an image display device adapted to display an image with a predetermined resolution so as to be able to communicate with the image display device, the program making the computer to: generate transmission image data with a resolution lower than a display resolution of the image display device, and transmit the generated transmission image data to the image display device.

According to this aspect of the invention, since the computer executing the program recorded on the information recording medium generates the transmission image data with the resolution lower than the display resolution of the image display device, and then transmits the transmission image data to the image display device, the amount of the data to be transmitted to the image display device can be reduced without performing the process with heavy load.

According to the aspects of the invention, the data amount of the image data to be transmitted to the image display device can be reduced without performing the process with heavy load.

### BRIEF DESCRIPTION OF THE DRAWINGS

The invention will be described with reference to the accompanying drawings, wherein like numbers reference like elements.

FIG. 1 is a diagram showing a schematic configuration of a display system according to an embodiment of the invention.

FIG. 2 is a block diagram showing a functional configuration of the display system.

FIG. 3 is a flowchart showing an operation of a PC.

FIGS. 4A and 4B are diagrams showing an example of the data amount in the case of transferring image data from the PC to a projector, wherein FIG. 4A shows a relationship between a setting value of an image data amount and the data amount, and FIG. 4B shows the above relationship as a graph.

FIGS. 5A and 5B are diagrams showing another example of the data amount in the case of transferring image data from the PC to the projector, wherein FIG. 5A shows a relationship between the setting value of an image data amount, and FIG. 5B shows the above relationship as a graph.

### DESCRIPTION OF AN EXEMPLARY EMBODIMENT

An embodiment to which the invention is applied will hereinafter be explained with reference to the accompanying drawings.

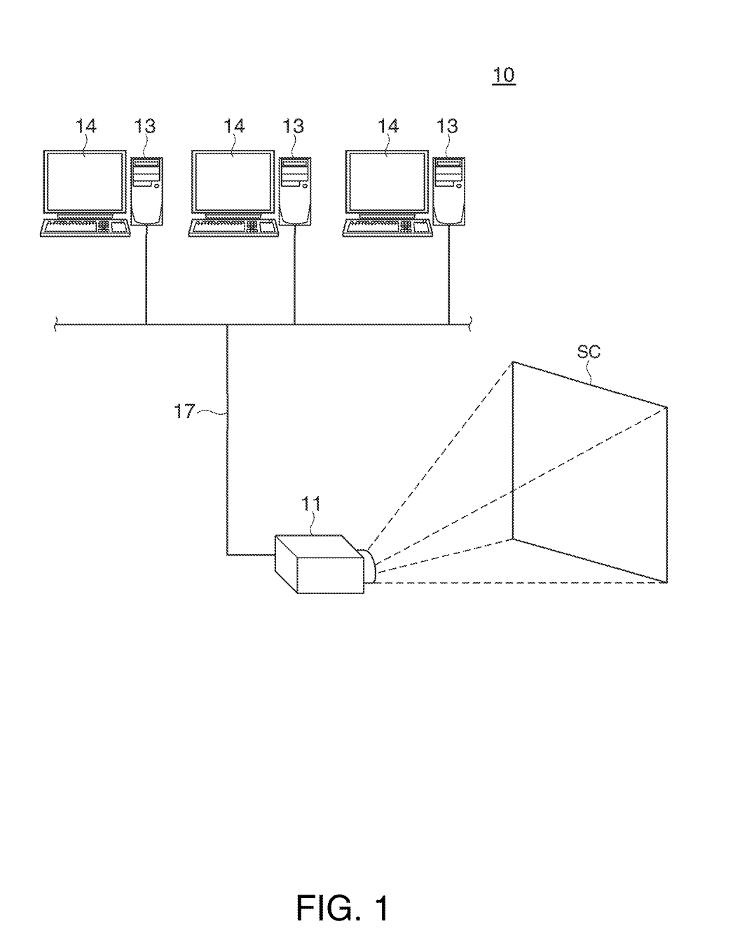

FIG. 1 is a diagram showing a schematic configuration of a display system 10 according to the embodiment to which the invention is applied. The display system 10 shown in FIG. 1 is configured by connecting a projector 11 as an image display device and personal computers (PCs) 13 as image supply devices for transmitting image data to the projector 11 to each other via a communication network 17 so as to be able to communicate with each other.

The projector 11 receives the image data transmitted from each of the PCs 13, and then projects an image on the screen based on the image data.

The PC 13 is provided with a monitor 14 (a display screen) having a display screen such as a liquid crystal display panel, and transmits the image data for making the projector 11 display the image presently displayed on the monitor 14 to the projector 11. The image data the PC 13 transmits to the projector 11 can be either of a still image and a moving image.

The communication network 17 is a network capable of bidirectional communication such as a local area network (LAN) composed of wired or wireless communication lines, and connects each of the PCs and the projector 11 to each other so as to be able to communicate with each other, and at the same time, makes the communication between the PCs 13 also possible.

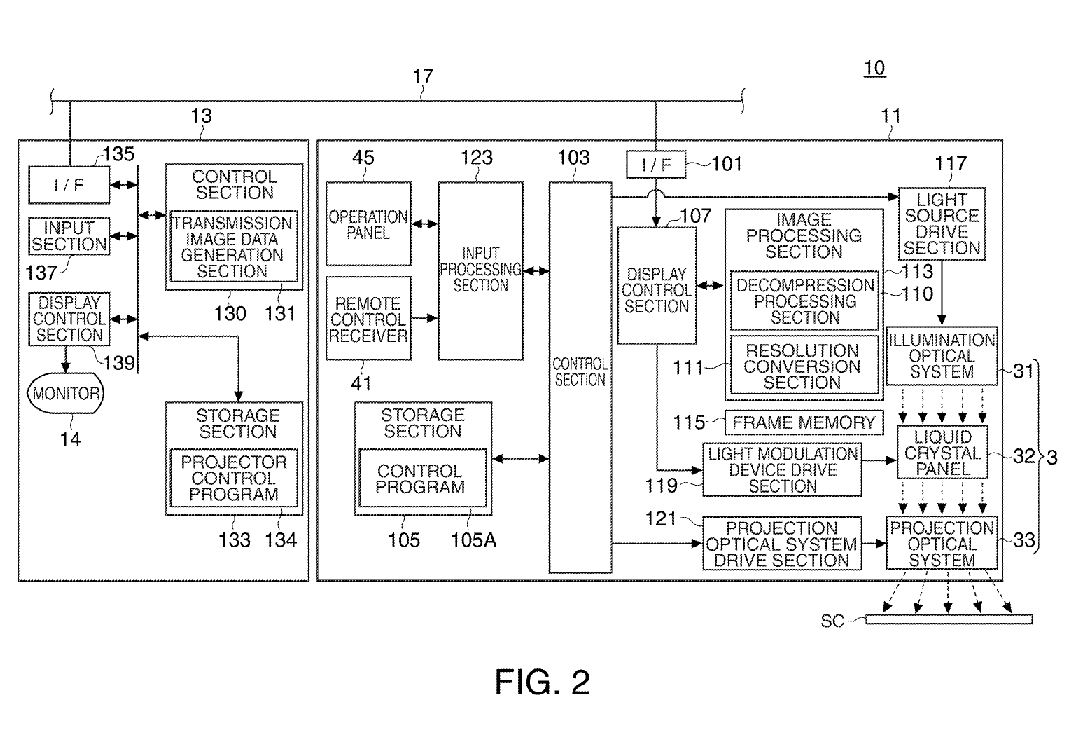

The PC 13 executes a projector control program 134 (FIG. 2) described later to thereby transmit the image data to the projector 11 via the communication network 17. Further, the PC 13 transmits and receives various types of data including control data and image data to and from other PCs 13.

FIG. 2 is a block diagram showing a configuration of the display system 10.

The projector 11 is provided with an I/F (interface) section 101 to be connected to external devices such as the PCs 13, a video playback device, or a DVD playback device. The external I/F section 101 is provided with, for example, an USB interface, a wired or wireless LAN interface, a VGA terminal to which an analog video signal is input, a Digital Visual Interface (DVI) to which a digital video signal is input, an S-video terminal to which a composite video signal such as NTSC, PAL, or SECAM is input, an RCA terminal to which a composite video signal is input, a D-terminal to which a composite video signal is input, and an HDMI connector compliant with the HDMI (registered trademark) standard. In the projector 11 according to the present embodiment, the LAN interface provided to the I/F section 101 is connected to the communication network 17.

The projector 11 is composed of an optical system for performing optical image formation and an image processing system for electrically processing the image signal in view of the general classification. The optical system is a projection section 3 (a display) composed of an illumination optical system 31, a liquid crystal panel 32 as a light modulation device, and a projection optical system 33. The illumination optical system 31 is provided with a light source formed of, for example, a xenon lamp, a super-high pressure mercury lamp, or a light emitting diode (LED). Further, the illumination optical system 31 can be provided with a reflector and an auxiliary reflector for guiding the light emitted by the light source to the liquid crystal panel 32, and can be a system provided with, for example, a lens group (not shown) for improving the optical characteristics of the projection light, a polarization plate, or a photochromic element for reducing the light intensity of the light emitted by the light source on the path leading to the liquid crystal panel 32.

The liquid crystal panel 32 receives the signal from the image processing system described later, and then modulates the light from the illumination optical system 31. The liquid crystal panel 32 is composed of three liquid crystal panels corresponding respectively to three primary colors of RGB in order to perform color projection. Therefore, the light from the illumination optical system 31 is separated into colored lights of three colors of RGB, and the colored lights enter the corresponding liquid crystal panels, respectively. The colored lights modulated while passing through the respective liquid crystal panels are combined by a combining optical system such as a cross dichroic prism, and then output to the projection optical system 33.

The projection optical system 33 is provided with, for example, a zoom lens for performing expansion and contraction of the image to be projected and adjustment of the focus, a zoom controlling motor for controlling the level of the zoom, and a focus adjusting motor for performing the focus adjustment. To this optical system, there are connected a projection optical system drive section 121 for driving the respective motors provided to the projection optical system 33 in accordance with the control of a control section 103, and a light source drive section 117 for driving the light source provided to the illumination optical system 31 in accordance with the control of the control section 103.

On the other hand, the image processing system is configured including the control section 103 for integrally controlling the whole of the projector 11 as a core component, and is provided with a storage section 105 storing data to be processed by the control section 103 and a control program 105A to be executed by the control section 103, an input processing section 123 for detecting an operation of the user via an operation panel 45 and a remote control receiver 41, a display control section 107 for processing the input image input via the I/F section 101, an image processing section 113 for performing image processing in accordance with the control of the display control section 107, and a light modulation device drive section 119 for driving the liquid crystal panel 32 based on the image signal output from the display control section 107 to thereby perform drawing.

The control section 103 reads out and executes the control program 105A stored in the storage section 105 to thereby control each section of the projector 11. The control section 103 detects the content of the operation performed by the operator based on the operation signal input from the input processing section 123, and then controls the display control section 107, the projection optical system drive section 121, and the light source drive section 117 in accordance with the operation to thereby project the image on a screen SC.

The exterior housing (not shown) of the projector 11 is provided with an operation panel 45 having various switches and indicator lamps. The operation panel 45 is connected to the input processing section 123. The input processing section 123 appropriately lights or blinks the indicator lamps of the operation panel 45 in accordance with the operation state and the setting state of the projector 11 following the control of the control section 103. Further, if the switch of the operation panel 45 is operated, the operation signal corresponding to the switch thus operated is output from the input processing section 123 to the control section 103.

Further, the projector 11 receives the infrared signal, which is transmitted by a remote controller (not shown) used by the operator in accordance with the button operation, with the remote control receiver 41. The remote control receiver 41 converts the infrared signal received from the remote controller into an analog voltage using a light receiving element, and then outputs the analog voltage to the input processing section 123. The input processing section 123 quantizes the analog voltage output by the remote control receiver 41, performs a process such as decoding thereon, and then outputs an operation signal representing the operation content in the remote controller described above to the control section 103.

The display control section 107 is connected to the I/F section 101. The image processing section 113 is connected to the display control section 107, and a frame memory 115 is connected to the image processing section 113.

The display control section 107 performs determination on whether the input image input via the I/F section 101 is an analog image or a digital image, determination on the image format (a frame rate, resolution, and the state of compression), and so on to thereby determine the necessary process for displaying the input image on the liquid crystal panel 32, and then controls the image processing section 113 to perform the process. Then the display control section 107 outputs the image signal processed by the image processing section 113 to the light modulation device drive section 119 to make the liquid crystal panel 32 display it.

The image processing section 113 develops the input image, which is input via the I/F section 101, on the frame memory 115 in accordance with the control of the display control section 107, then performs various conversion processes such as analog/digital conversion, interlace/progressive conversion, or resolution conversion if necessary to thereby generate the image signal with the format set in advance, and then outputs it to the display control section 107. In detail, the image processing section 113 is provided with a decompression processing section 110 and a resolution conversion section 111 (a resolution converter). The decompression processing section 110 decompresses (decodes) the image or a frame of the moving image thus compressed, and the resolution conversion section 111 performs the process of converting the resolution of the input image in accordance with the display resolution of the liquid crystal panel 32. For example, in the case in which the resolution of the image received from the PC13 is lower than the display resolution of the liquid crystal panel 32, the decompression processing section 110 performs a process of converting the image into an image with the display resolution of the liquid crystal panel 32. Thus, the projector 11 can perform display with high quality even if the input image has a resolution lower than the display resolution of the liquid crystal panel 32.

Under the control of the control section 103, the image processing section 113 decodes the image data, which is received by the I/F section 101 and then obtained by the display control section 107, using the decompression section 110 if necessary, and then develops it on the frame memory 115 as an image of one frame. Then, the image processing section 113 performs the resolution conversion by the resolution conversion section 111 on the image data developed on the frame memory 115, and then generates the image signal based on the image data thus converted. The display resolution of the liquid crystal panel 32 is stored in the display control section 107 in advance, or set by the control section 103 to the display control section 107 in accordance with the setting data stored in the storage section 105.

Further, the image processing section 113 can perform various types of image processing such as a keystone correction, a color compensation corresponding to a color mode, and image expansion/contraction process in accordance with the control of the display control section 107.

Meanwhile, the PC 13 is provided with a control section 130 having a CPU, a ROM storing a primary control program, a RAM for temporarily storing a program and data as a processing target, and so on, and executing the control program in the ROM to thereby control each section of the PC 13, and a storage section 133 for storing various application programs to be executed by the control section 130, data to be processed, and so on.

The control section 130 executes a projector control program 134 as one of the application programs stored in the storage section 133 to thereby realize a function of transmitting the image data to the projector 11. When performing the function, the control section 130 functions as a transmission image data generation section 131, and performs various processes such as determination of the resolution of the image to be displayed on the projector 11, a compression process (encoding), and resolution conversion. The type of the compression process the transmission image data generation section 131 can perform is not particularly limited, and various types of compression codecs for still images and moving images such as JPEG, GIF, PNG, Motion JPEG, MPEG, or ITU-T H-series (H.261, H.263, H.264) are available.

The PC 13 is provided with an I/F (interface) section 135 having a LAN interface to be connected to the communication network 17 and so on, an input section 137 for detecting the operation of an input device such as a keyboard or a mouse, and then outputting an operation signal to the control section 130, and a display control section 139 (a display) for displaying various images or the like on the monitor 14 in accordance with the control of the control section 130. The display control section 139 generates a display signal corresponding to the display resolution of the monitor 14 based on the data of the image to be displayed on the screen, and then drives the monitor 14.

When executing the projector control program 134 described above, the control section 130 generates the image data for making the projector 11 display the image presently displayed on the monitor 14 by the display control section 139, then generates the transmission image data based on the image data, and then transmits it to the projector 11. Thus, the projector 11 displays the same image as the image presently displayed on the monitor 14.

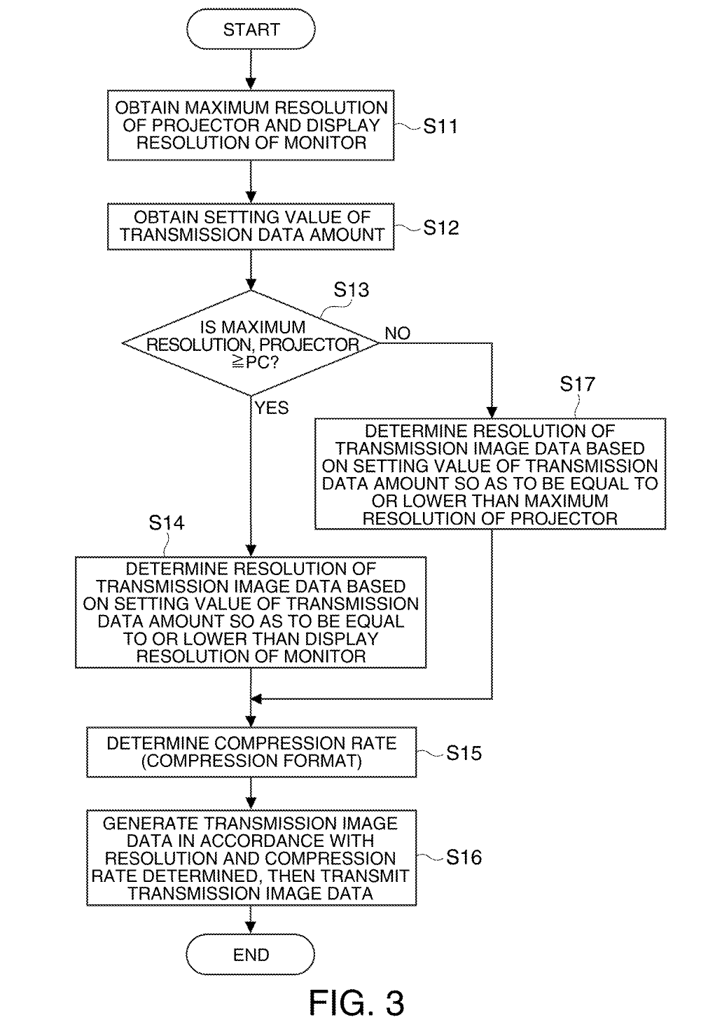

FIG. 3 is a flowchart showing the operation of the PC 13, and in particular shows the operation of the transmission image data generation section 131 in the case in which the control section 130 executes the projector control program 134.

The operation shown in FIG. 3 is an operation started by the execution of the projector control program 134, and for transmitting the image data to the projector 11 to thereby make the projector 11 project a desired image of the user operating the PC 13. When performing the operation of FIG. 3, the control section 130 of the PC 13 functions as a transmitter in cooperation with the I/F section 135, the transmission image data generation section 131 functions as a transmission image data generator, and the display control section 107 of the projector 11 functions as a receiver in cooperation with the I/F section 101.

The transmission image data generation section 131 firstly obtains (step S11) the maximum resolution of the projector 11 and the display resolution of the monitor 14. Although the maximum resolution denotes the maximum resolution of the image to be projected actually on the screen SC by a projection section 3, the maximum display resolution of the liquid crystal panel 32 can also be used. The PC 13 is capable of transmitting and receiving the control data with the projector 11 to thereby obtain the information regarding the maximum resolution of the projector 11. Further, there can be cited a method that the PC 13 identifies the model of the projector 11, and then obtains the maximum resolution of the model from an external device, or a method that the PC 13 previously stores the maximum resolution of the projector 11 to the storage section 133 together with the projector control program 134.

The transmission image data generation section 131 obtains (step S12) the setting value of the transmission data amount designated by the operation of the user, a setting value of the projector control program 134, and so on. The setting value of the transmission data amount is a value for setting the data amount of the transmission image data to be transmitted from the PC 13 to the projector 11, and can be set to six levels of −3, −2, −1, ±0, +1, and +2 in the present embodiment. The data amount is not for defining the data amount itself of the transmission image data, but is an indication indicating what extent the data amount is reduced to.

Here, the transmission image data generation section 131 compares (step S13) the maximum resolution of the projector 11 obtained in the step S11 and the display resolution of the monitor 14 with each other. If the maximum resolution of the projector 11 is higher (YES in the step S13), the transmission image data generation section 131 determines (step S14) the resolution of the transmission image data based on the setting value of the transmission data amount obtained in the step S12. In the step S14, the resolution of the transmission image data is set so as to be equal to or lower than the display resolution of the monitor 14.

In contrast thereto, if the resolution of the monitor 14 is higher than the maximum resolution of the projector 11 (No in the step S13), the transmission image data generation section 131 determines (step S17) the resolution of the transmission image data so that the resolution of the transmission image data becomes equal to or lower than the maximum resolution of the projector 11 based on the setting value of the transmission data amount.

Subsequently, the transmission image data generation section 131 determines (step S15) the compression rate of the image data based on the setting value of the transmission data amount. The transmission image data generation section 131 is capable of compressing the image data at a plurality of levels of compression rate with a single compression method (e.g., JPEG format). Further, the transmission image data generation section 131 is capable of performing the process of compressing the image data using a plurality of types of compression formats with respective compression rates different from each other. Further, it is also possible to adopt a configuration capable of performing the compression process at a plurality of levels of compression rate in each of the plurality of compression formats. In the step S15, the transmission image data generation section 131 determines the compression format, the compression rate, or both of the compression format and the compression rate previously set corresponding to the setting value of the transmission data amount.

Subsequently, the transmission image data generation section 131 performs the compression and the resolution conversion on the image data as the transmission target using the resolution of the transmission image data determined in the step 14 on the step 17, and the compression rate and the compression format determined in the step S15 to thereby generate the transmission image data, and then transmits (step S16) the transmission image data to the projector 11.

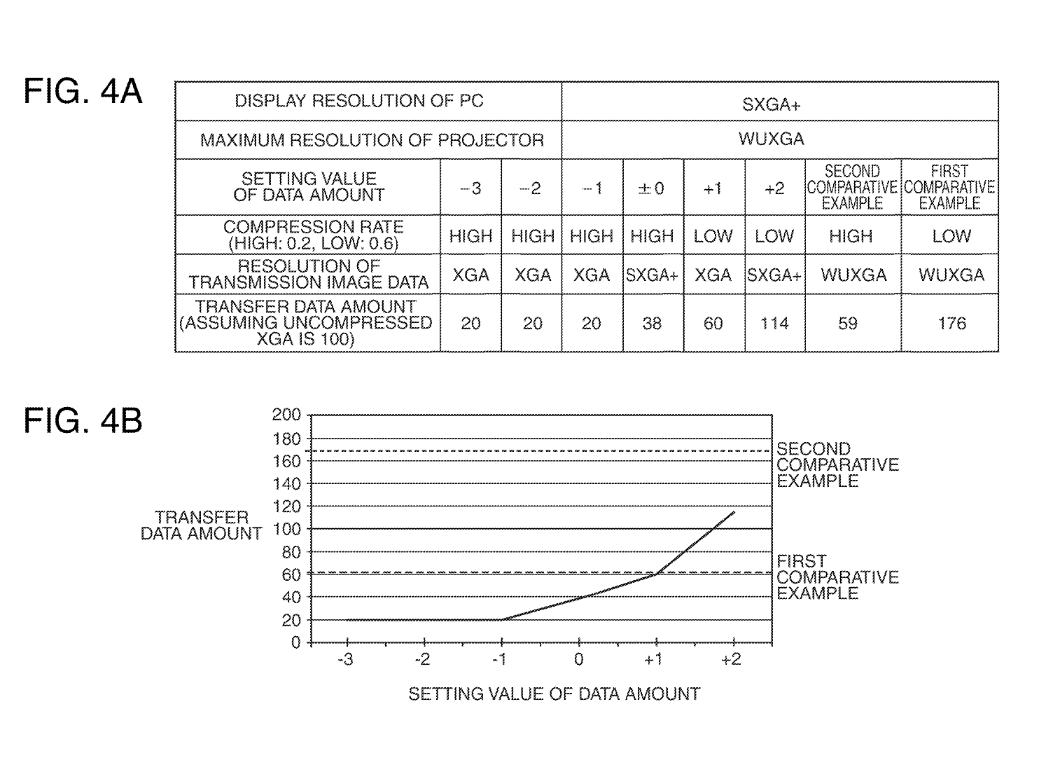

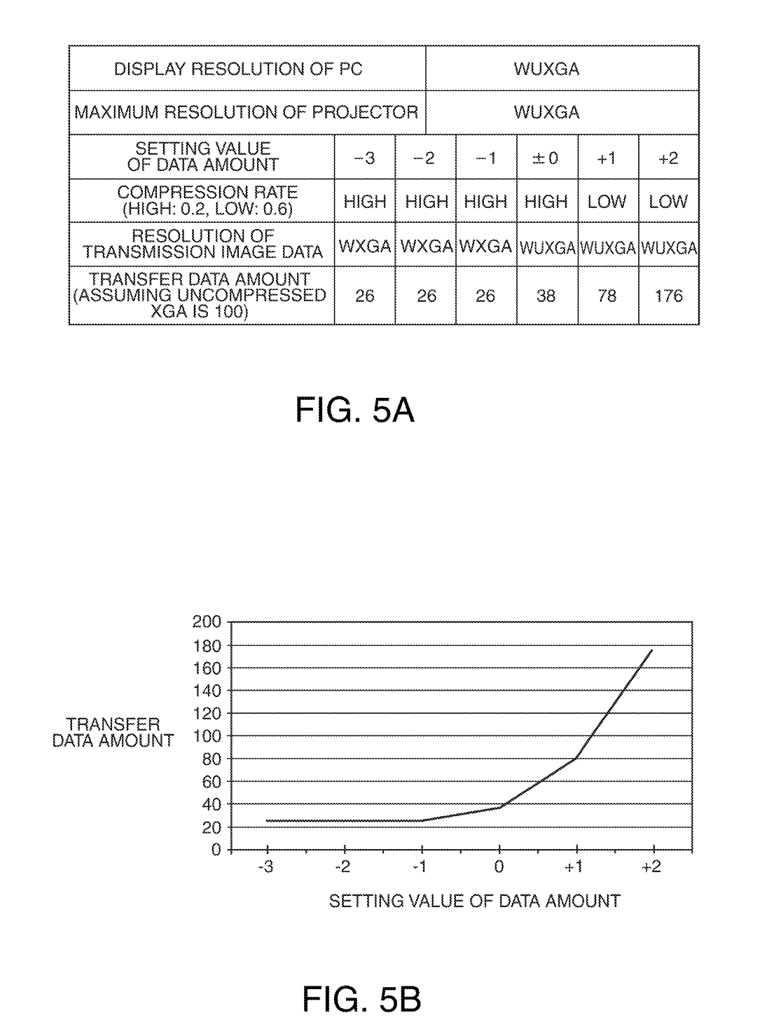

FIGS. 4A, 4B, 5A, and 5B are diagrams showing examples of the data amount in the case of transferring image data from the PC 13 to the projector 11, wherein FIGS. 4A and 5A show a relationship between the setting values of an image data amount and the data amount, and FIGS. 4B and 5B show the above relationship as a graph.

In the example shown in FIGS. 4A and 4B, the display resolution of the PC 13 is SXGA+ (1280×1024), and the maximum resolution of the projector 11 is WUXGA (1920×1200). Therefore, the resolution of the transmission image data the transmission image data generation section 131 generates is determined to be equal to or lower than SXGA+. It is arranged that the setting value of the data amount can be set to the six levels from −3 to +2 as described above. FIG. 4A shows an example of a correspondence between the setting values of the transmission image data and the resolutions of the transmission image data, and the data amounts of the transmission image data to be transferred from the PC 13 to the projector 11 in the case in which the setting value of the data amount is set to the six levels from −3 to +2 in comparison with each other.

Further, the transfer data amounts in the case of setting the resolution of the transmission image data to the maximum resolution of the projector 11 are shown as first and second comparative examples. It should be noted that the first and second comparative examples correspond to the case in which, for example, the PC 13 performs the resolution conversion for making the resolution of the transmission image data equal to the maximum resolution of the projector 11, and then transmits the transmission image data to the projector 11.

If the setting value of the data amount is set to the value from −3 to −1, the compression rate is set to high compression, and the resolution of the transmission image data is set to XGA (1024×768). The transfer data amount on this occasion is about 20 assuming that the transfer data amount in the case in which the resolution is XGA without compression is 100. Further, in the case in which the setting value of the data amount is a value from 0 to +1, although the resolution is raised to SXGA+, the transfer data amounts are 38 and 60, respectively, at the highest. In the case in which the setting value of the data amount is +2, since the compression rate is set to low compression in the high resolution (SXGA+), the transfer data amount becomes 114.

In contrast thereto, in the first comparative example, although the compression rate is high compression, the transfer data amount reaches 59, which is in the same range as in the case (the setting value of the data amount is +1) of setting the compression rate to low compression. Further, in the second comparative example of setting the compression rate to low compression, the transfer data amount reaches as high as 176. As shown in FIG. 4B, the difference in the data amount is noticeable, and the transfer data amount is far smaller than the value in the second comparative example even in the case of the setting value of +2. As described above, by fitting the resolution of the transmission image data to the smaller one of the maximum resolution of the projector 11 and the display resolution of the monitor 14, the transfer data amount can dramatically reduced. Since the number of pixels (786,432) in the case of in which the resolution is XGA is smaller than the number of pixels (2,304,000) in the case of WUXGA, the effectiveness is noticeable.

Further, in the example shown in FIGS. 5A and 5B, since the display resolution of the PC 13 and the maximum resolution of the projector 11 are both WUXGA, the resolution of the transmission image data the transmission image data generation section 131 generates is determined to be equal to or lower than WUXGA. In this case, the transmission image data generation section 131 sets the resolution of the transmission image data to be equal to or lower than WUXGA, specifically sets to WXGA and WUXGA in this example. In the case in which the resolution is WXGA, the transfer data amount is 78 even with the low compression rate (the setting value of the transfer data amount is +1), which is significantly smaller than in the second comparative example shown in FIG. 4A. In the case in which the setting value of the transfer data amount is +2, although the resolution is equal to the resolution of the projector 11 and the compression rate is set to the low compression rate, the transfer data amount is extremely large since the maximum image quality is selected in this case. In other words, although the transfer data amount is not reduced giving priority to the image quality and the reduction in the processing load of the projector 11 if the transfer data amount is set to the maximum, the transfer data amount can dramatically be reduced if necessary.

As described above, since the display system 10 according to the present embodiment to which the invention is applied is provided with the projector 11 for displaying an image with a predetermined display resolution and the PC 13 connected to the projector 11 so as to be able to communicate therewith, the PC is provided with the transmission image data generation section 131 for generating the transmission image data with a resolution lower than the display resolution of the projector 11, and the control section 130 and the I/F section 135 for transmitting the transmission image data generated by the transmission image data generation section 131 to the projector 11, and the projector 11 is provided with the I/F section 101 and the display control section 107 for receiving the transmission image data transmitted from the PC 13, the resolution conversion section 111 for generating the image data for display suitable for a predetermined display resolution based on the transmission image data received by the I/F section 101, and the display control section 107 for displaying the image based on the image data for display generated by the resolution conversion section 111, the amount of the data to be transmitted to the projector 11 can be reduced without performing the process with heavy load by the PC 13 generating the transmission image data with a resolution lower than the display resolution of the projector 11 and then transmitting it to the projector 11.

Here, the PC 13 obtains the maximum resolution of the projector 11 and then determines the resolution of the transmission image data so as to be equal to or lower than the maximum resolution instead of setting the resolution of the transmission image data to be transmitted to the projector 11 to low resolution across the board. Therefore, there is no possibility that the resolution of the transmission image data is set to a resolution extremely lower than the maximum resolution of the projector 11 to thereby incur degradation of display quality of the projector 11 or increase in the load on the resolution conversion section 111. Further, there is no chance that the resolution is set to be higher than the maximum resolution of the projector 11 as in the case in which the resolution of the transmission image data is previously set to a single value. In other words, since the PC 13 obtains the maximum resolution of the projector 11, and then determines the resolution of the transmission image data based on the maximum resolution, the transfer data amount can be reduced, and at the same time, the transmission image data with appropriate resolution can be transmitted so as not to cause the problem such as degradation of display quality.

Further, since the PC 13 is provided with the display control section 139 having the monitor 14 for displaying an image, and the transmission image data generation section 131 generates the transmission image data for displaying the image, which is presently displayed on the monitor 14 by the display control section 139, by the projector 11, the image data can be transmitted to the projector 11 by the process with low load.

Further, since the transmission image data generation section 131 generates the transmission image data with resolution equal to or lower than the display resolution of the monitor 14, the amount of the data to be transmitted to the projector 11 can be reduced by the process with lower load.

Further, since the transmission image data generation section 131 generates the transmission image data compressed with a predetermined compression format, the amount of the data of the image data to be transmitted from the PC 13 to the projector 11 can be made smaller.

The display system 10 is composed of the projector and the plurality of PCs 13 connected to each other via the communication network 17 so as to be able to communicate with each other, and has the configuration in which the PCs 13 are capable of communicating with each other via the communication network 17, and therefore, the communication channel for transmitting the image data from one of the PCs 13 to the projector 11 can be used for the communication between other two of the PCs 13. In this case, since the PC 13 reduces the data amount of the transmission image data the PC 13 transmits to the projector 11, there is no chance of occupying the band of the communication network 17. Therefore, the transmission image data can efficiently be transmitted to the projector 11 without exerting a substantial influence on the operation of the communication network 17 such as the communication between other PCs 13.

Further, the transmission image data generation section 131 generates the transmission image data compressed with the compression format selected from a plurality of compression formats, and is configured to be able to set the resolution of the transmission image data to a plurality of levels to thereby be able to set the setting value of the data amount of the transmission image data to a number of levels by selecting the compression format and the resolution of the transmission image data, and is therefore capable of setting the optimum condition with good balance between the load of the process and the data amount.

It should be noted that the embodiment described above is nothing more than an example of a specific aspect to which the invention is applied, and therefore, does not limit the invention. Therefore, it is also possible to apply the invention as an aspect different from the embodiment described above. For example, although in the embodiment described above, the explanation is presented citing the configuration in which the PC 13 is provided with the monitor 14, and compares the display resolution of the monitor 14 and the maximum resolution of the projector 11 with each other to thereby generate the transmission image data due to the function of the transmission image data generation section 131 as an example, the invention is not limited thereto, but there can also be adopted a configuration in which the display control section 139 has a virtual display screen. Specifically, although the display control section 139 does not actually output the image signal, a display screen is virtually disposed, and the image signal fitted to the display resolution of the display screen is generated, or a process for generating the image data for generating the display signal is performed. Alternatively, it is also possible that the resolution of the virtual display screen is set alone. The configuration can be adopted no matter whether or not the PC 13 is provided with the monitor 14. The PC 13 on this occasion can perform the operation shown in FIG. 3 based on the display resolution of the virtual display screen. Further, the PC 13 can adopt the configuration of commonly using one monitor 14 with other computer, or the configuration of displaying the screen on the monitor of another computer connected via the communication network.

Further, although in the embodiment described above the explanation is presented citing, as an example, the configuration of performing the modulation using the three transmissive or reflective liquid crystal panels 32 corresponding to the respective colors of RGB, the invention is not limited thereto, but can be configured using a system including one liquid crystal panel and a color wheel combined with each other, a system using three digital mirror devices (DMD), a system using one digital mirror device and a color wheel combined with each other, and so on. Here, in the case of using just one liquid crystal panel or the DMD as the light modulation device, the member corresponding to the combining optical system such as the cross dichroic prism is unnecessary. Further, besides the liquid crystal panel or the DMD, any configuration capable of modulating the light emitted from the light source can be adopted without problems.

Further, each of the functional sections shown in the display system 10 shown in FIG. 2 is for showing the functional configuration of the projector 11 and the PC 13, and the specific mounting forms are not particularly limited. In other words, it is not necessarily required to install the hardware corresponding individually to each of the functional sections, but it is obviously possible to adopt the configuration of realizing the functions of the plurality of functional sections by one processor executing the program. Further, a part of the function realized by software in the embodiment described above can also be realized by hardware, or a part of the function realized by hardware can also be realized by software. Besides the above, the specific detailed configuration of each of other sections of the projector 11 and the display system 10 can arbitrarily be modified within the scope or the spirit of the invention.

What is claimed is:

1. An image supply device capable of communicating with an image display device adapted to display an image with a predetermined display resolution, comprising:
a transmission image data generator adapted to generate transmission image data with a resolution lower than a display resolution of the image display device; and
a transmitter adapted to transmit the transmission image data generated by the transmission image data generator to the image display device.

2. The image supply device according to claim 1, further comprising:
a display having one of a display screen and a virtual display screen each adapted to display an image,
wherein the transmission image data generator generates the transmission image data with which the image display device displays an image presently displayed on one of the display screen and the virtual display screen by the display.

3. The image supply device according to claim 2, wherein
the transmission image data generator generates the transmission image data with a resolution one of equal to and lower than the display resolution of one of the display screen and the virtual display screen of the display.

4. The image supply device according to claim 1, wherein
the transmission image data generator generates the transmission image data compressed with a predetermined compression format.

5. The image supply device according to claim 1, wherein
the transmission image data generator generates the transmission image data compressed with a compression format selected from a plurality of compression formats, and is configured so as to be able to set the resolution of the transmission image data to a plurality of levels, and
the setting value of a data amount of the transmission image data can be set to a plurality of levels by selecting the compression format and the resolution of the transmission image data.

6. A display system comprising:
the image supply device according to claim 1; and
an image display device adapted to display an image with the predetermined display resolution,
the image display device includes
a receiver adapted to receive the transmission image data transmitted from the image supply device,
a resolution converter adapted to generate image data for display suitable for the predetermined display resolution based on the transmission image data received by the receiver, and
a display adapted to display an image based on the image data for display generated by the resolution converter.

7. The display system according to claim 6, wherein
there is provided a configuration in which the image display device and a plurality of the image supply devices are connected to each other via a communication network so as to be able to communicate with each other, and the image supply devices can communicate with each other via the communication network.

8. An image supply method comprising:
allowing a device connected to an image display device adapted to display an image with a predetermined display resolution so as to be able to communicate with the image display device to generate transmission image data with a resolution lower than a display resolution of the image display device; and to transmit the transmission image data to the image display device.

9. A computer-readable information recording medium storing a program executable by a computer connected to an image display device adapted to display an image with a predetermined resolution so as to be able to communicate with the image display device,
the program allowing the computer to:
generate transmission image data with a resolution lower than a display resolution of the image display device; and
transmit the generated transmission image data to the image display device.
